(19) United States
(12) Patent Application Publication
(10) Pub. No.: US 2014/0212845 A1
(43) Pub. Date: Jul. 31, 2014

(54) SYSTEM AND METHOD FOR IMPROVING CEMENT RETENTION IN IMPLANT-SUPPORTED ABUTMENT

(71) Applicants: Chandur Prem Karl Wadhwani, Bellevue, WA (US); Kwok-Hung Chung, Bellevue, WA (US)

(72) Inventors: Chandur Prem Karl Wadhwani, Bellevue, WA (US); Kwok-Hung Chung, Bellevue, WA (US)

(21) Appl. No.: 14/166,450

(22) Filed: Jan. 28, 2014

Related U.S. Application Data
(60) Provisional application No. 61/757,415, filed on Jan. 28, 2013.

(51) Int. Cl. A61C 8/00; A61C 13/08

(52) U.S. Cl. CPC A61C 8/0069; A61C 8/0074; A61C 8/0022; A61C 13/08
USPC 433/174; 433/173

(57) ABSTRACT

The current disclosure is directed to a dental implant system and method that modifies the screw access channel of an implant-supported abutment in order to improve cement retention within the abutment chamber and to improve retention strength of prosthesis. The cement-retaining system comprises an abutment screw and a longitudinal extension of the abutment screw that channels excess cement into the chamber. The extension may be made from a variety of materials, including metal alloys, plastic materials, or materials that have a low melting point and can be removed in order to allow easy access to the screw head. In one implementation, the extension is affixed at the head of an abutment screw. In other implementations, the extension and the abutment screw are a continuous unit. Experiments demonstrate that the extension increases the volume of cement within the abutment chamber and improves the retention ability of the abutment-restoration complex.

### CROSS-REFERENCE TO RELATED APPLICATION

This application claims the benefit of Provisional Application No. 61/757,415, filed Jan. 28, 2013.

### TECHNICAL FIELD

The current application is generally related to the field of dentistry, in particular, to systems and methods for improving cement retention in implant-supported abutment.

### BACKGROUND

Dental implants are used to restore esthetics and proper function of lost teeth. Cementation is a routine dental procedure commonly used to attach a coronal restoration, also known as prosthesis, to an implant-supported abutment by applying luting cement to the intaglio surface of the restoration. When too much cement is used, the excess cement extrudes from the implant restoration-abutment assembly into subgingival margins, causing inflammation and may lead to peri-implant disease and even loss of implant. The ability to use the correct amount of cement during cementation is extremely challenging. As a result, scientists seek techniques to control cement excess and improve cement retention.

### SUMMARY

The current disclosure is directed to a dental implant system and method that modifies the screw access channel of an implant-supported abutment, in order to improve cement retention within the abutment chamber and to improve retention strength of a restoration. The cement-retaining system comprises an abutment screw and a longitudinal extension of the abutment screw that guides excess cement into the chamber. The extension may be made from a variety of materials, including metal alloys, plastic materials, or materials that have a low melting point and can be removed in order to allow easy access to the screw head. In one implementation, the extension is affixed at the head of an abutment screw. In other implementations, the extension and the abutment screw are a continuous unit. Experiments demonstrate that the extension increases the volume of cement within the abutment chamber and improves the retention ability of the abutment-restoration complex.

### BRIEF DESCRIPTION OF THE DRAWINGS

FIG. 1 shows an exploded isometric view of a dental prosthetic implant system.

FIG. 2A shows a closed abutment.

FIG. 2B shows an open abutment.

FIG. 2C shows an internal-vent abutment.

FIG. 3 shows percentage of cement extruded from groups of closed abutment, open abutment and internal-vent abutment.

FIG. 4A-B show cement flow patterns in an open abutment and an internal-vent abutment.

FIG. 5 shows means and standard deviations of retention force required to dislodge the cemented restoration from groups of closed abutment, open abutment and internal-vent abutment.

FIG. 6A shows an isometric view of a cement-retaining abutment screw.

FIG. 6B shows a dental prosthetic implant system with the cement-retaining abutment screw.

FIG. 7A shows an example of a conical-shaped extension as a separate unit from an abutment screw

FIG. 7B shows the extension seated within an abutment.

FIG. 8 shows mean retention forces required to dislodge cemented copings from groups of closed abutment, open abutment and insert abutment.

FIG. 9 shows the cement flow pattern in an insert abutment.

FIG. 10A shows a closed zirconia anterior abutment.

FIG. 10B shows an open zirconia anterior abutment.

FIG. 10C shows an insert abutment with a metal extension.

FIG. 11 shows means and standard deviations of retention force required to dislodge cemented restorations from groups of closed abutment, open abutment and insert abutment.

FIG. 12 A shows a cement distribution pattern for a restoration in the CA group.

FIG. 12 B shows a cement distribution pattern for a first restoration in the OA group.

FIG. 12 C shows a cement distribution pattern for a second restoration in the OA group.

FIG. 12 D shows a cement distribution pattern for a restoration in the IA group.

### DETAILED DESCRIPTION

The current disclosure is directed to a dental implant system and method that modifies the screw access channel of an implant-supported abutment in order to improve cement retention within the abutment chamber and retention strength of a restoration. The system provides an internal cement-retaining mechanism by dispersing cement filling the abutment chamber. In the following discussion, components of a dental prosthetic implant system are introduced in a first subsection. A second subsection discusses various screw-access-chamber modifications and their effects on cement distribution and retention. A third subsection introduces a cement-retaining system. A fourth subsection discusses one implementation in which a titanium abutment is modified with an acrylic extension. A fifth subsection discusses a second implementation in which a zirconia abutment is modified with a metal extension.

### A Dental Prosthetic Implant System

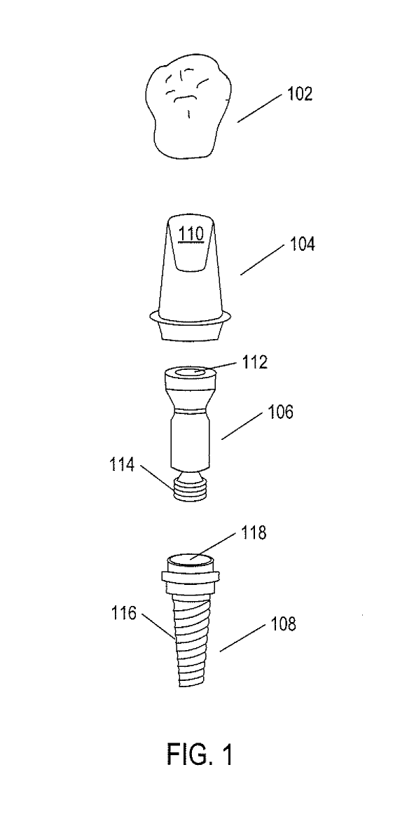

FIG. 1 shows an exploded isometric view of a dental prosthetic implant system. A dental prosthetic implant system comprises a dental prosthesis 102, such as a crown or a denture, an abutment 104, an abutment-retaining screw 106, and a dental implant or fixture 108. The implant 108 may be made of metal, such as titanium, and has an external thread 116, which is inserted into a hole drilled in the jawbone of a patient. The implant 108 also has an internally threaded socket 118 to receive the threaded end of the screw 106. The implant 108 takes the place of a natural tooth root and serves an anchor or foundation for the prosthodontic restoration 102. The abutment 104 connects the implant 108 and the dental prosthesis 102. The abutment 104 has a passage or chamber 110 that aligns with the socket 118 in the implant 108. The abutment 104 is anchored to the implant 108 with the screw 106 that passes through the chamber 110 in the abutment 104 and is screwed into the implant socket 118. The abutment-retaining screw 106 generally has an externally threaded end 114 and a screwdriver receiving socket 112 on the head of the abutment screw for engagement with a screwdriver or other suitable driving tools. A dental prosthesis 102 that resembles a tooth or a group of teeth can be secured to the abutment 104 with a screw, or it can be secured to the abutment using luting cement.

The use of cementation as a method to secure an implant restoration to an abutment has many advantages, including esthetics, control of occlusion, less demanding implant placement, low cost, and improved passive fit for multiple connected units, Crowns or other types of prostheses cemented to abutments are fabricated to fit together congruently, with the space between components filled with luting cement. When a crown is being seated, there is a limited space for the cement to fill. The correct quantity of cement needed to attach a crown to an abutment lies within a narrow range. If too little cement is used, the space may not be completely filled, causing potential for leakage and loss of retention. On the other hand, if too much cement is used, the excess cement extrudes from the crown-abutment system. The excess cement may cause many problems, including having the effect of occlusal alteration, increased difficulty in cleanup, and the possibility of detrimental effects on tissue health around the implant. Studies indicate that 80% of peri-implant disease is a direct result of bacterial colonization of extruded cement, and excess cement is a major cause of peri-implantitis.

A survey on cement application techniques in luting implant-supported crowns revealed a lack of consensus in the dental community as to the appropriate quantity of cement needed. In recent studies it was revealed that the majority of dentists used far more cement than is required for an abutment with an occluded screwdriver receiving socket. In order to minimize the extrusion of excess cement, various techniques have been developed, including modified cementation procedures to limit the total amount of cement used and external venting of crowns. External venting of crowns has been shown to improve the marginal fit of crowns by decreasing hydrostatic pressure during seating and to increase retentive ability. However, venting a crown may alter the structural integrity and decrease the strength of the crown. Alternatively, internal venting techniques using space within the abutment chamber may be an effective approach to retain more cement inside the chamber and improve the seating of cement-retained implant restorations.

### Effects of Screw-Access-Chamber Modifications on Cement Flow and Retention

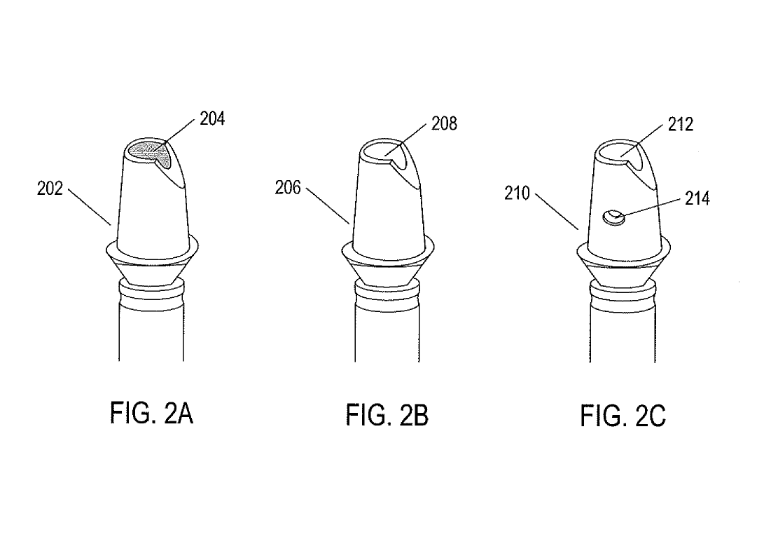

One of the methods of managing the abutment chamber prior to cementation of a restoration is to partially or completely fill the chamber with silicone impression material. Such methods are used to prevent cement from reaching the head of the abutment screw and later complicating clinical access to the screw should it become necessary. FIG. 2A shows a closed abutment (CA). In the closed abutment 202, the abutment chamber 204 is filled with composite material, limiting the ability to retain cement within the abutment. Alternatively, the abutment chamber may be left open to allow the cement to flow into the chamber. FIG. 2B shows an open abutment (OA). In this case, the chamber 208 within the abutment 206 provides an internal reservoir for excess cement to be retained within the restoration-abutment system rather than allowing the excess cement to extrude out of the system as the cemented restoration is being seated. The OA has proven to reduce the amount of cement extruded at the restoration-abutment margin as well as improve retention of the cement used. One drawback of the OA is that due to the high viscosity of luting cement, cement flow inside the abutment is limited by air entrapment or bubbles, which limit the amount of cement held within the abutment. To overcome this issue, the abutment can be modified by placing two vent holes within the wall of the abutment. The modified abutment is referred to as the internal-vent abutment (IVA). FIG. 2C shows an IVA. The IVA 210 has an open chamber 212, similar to the OA, with the addition of two holes 214 located 180° apart and approximately 3 mm below the occlusal surface. The two vent holes may also serve as an internal reservoir, in addition to the open chamber, for excess cement that may otherwise be extruded through the restoration-abutment margin.

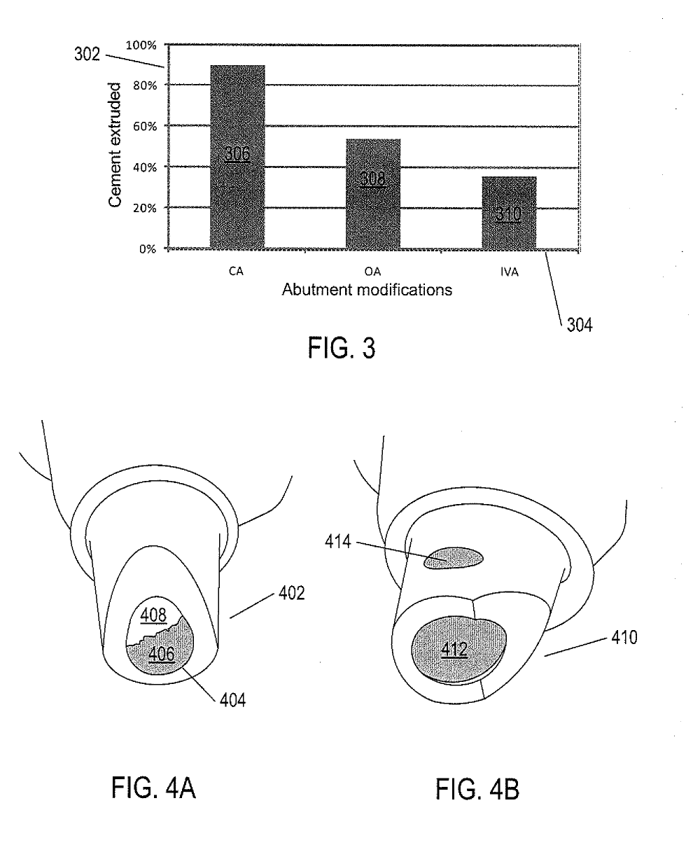

Differences between CA, OA and IVA approaches have been investigated with respect to the amount of cement extruded at the abutment-crown margin and the retention force required to dislodge the cemented restoration from the abutment. FIG. 3 shows percentage of cement extruded from groups of CA, OA and IVA. In FIG. 3, the vertical axis 302 represents percentage of cement extruded from abutments, and the horizontal axis 304 represents the type of abutments. Vertical bars, such as vertical bar 306, represent the percentage of cement extruded from the abutment. The CA group 306 extruded out of the system a mean of 90% of the total cement placed within the crown, the OA group 308 extruded a mean of 54% of the total cement, and the IVA group 310 extruded a mean of 36% of the total cement. The internal venting in the OA group and IVA group affects how the cement flows within the abutment chamber, resulting in less cement extrusion and an increased amount of cement retained in the chamber.

FIG. 4A-B show cement flow patterns in an open abutment and an internal-vent abutment. Cement flow patterns indicate in the OA 402 of FIG. 4A, the chamber 404 is only partially filled with cement 406 mostly on the occlusal surface, leaving a void space 408 within the cement layer. But in the IVA 410 of FIG. 4B, a better infill of the chamber 412 was observed, suggesting that the two vent holes 414 allow air to escape more readily, which prevents the formation of bubbles and increases the amount of cement stored within the abutment compared to the OA. The two vent holes 414 wall are also filled with cement.

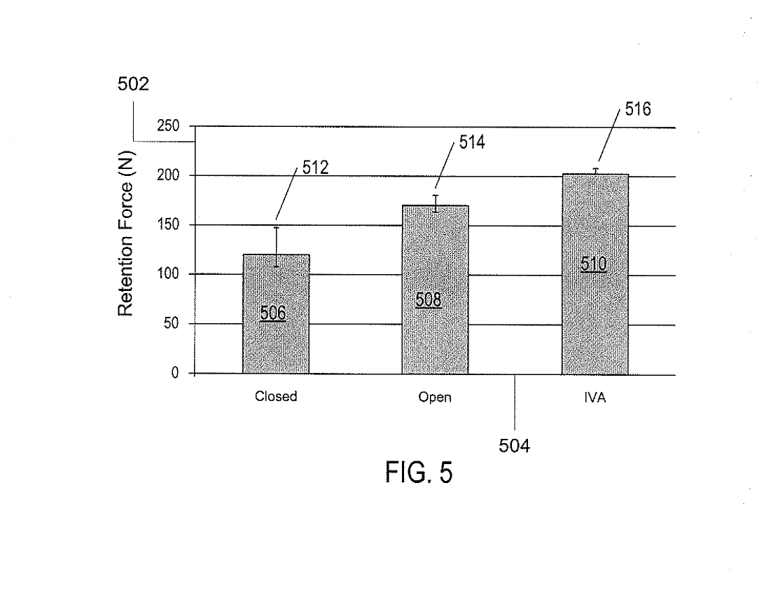

FIG. 5 shows means and standard deviations of retention force required to dislodge the cemented restoration from groups of closed abutment, open abutment and internal-vent abutment. In FIG. 5, the vertical axis 502 represents the mean retention force and the horizontal axis 504 represents the type of abutment. Vertical bars, such as vertical bar 506, represent the mean retention force required for each group of abutments. Vertical lines, such as vertical line 512, represent the standard deviation of the retention force for each type of abutment. The mean retention force required to remove the crown from the abutment is calculated as 119.6 N for the CA group 506, 158.0 N for the OA group 508, and 191.5 for the IVA group 510, with a standard deviation of 18.0 N for the CA group 512, 9.5 N for the OA group 514, and 11.7 N for the IVA group 516. Internal openings with two vent holes resulted in significantly higher mean retention values compared to the open or sealed screw access groups. Note that there is a correlation between the amount of cement retained internally in the system and the retentive force required to remove the crown from the abutment. Placement of two vent holes improves retention by altering cement distribution within the abutment chamber. Several factors such as the number of vent holes, location, and vent diameter may affect the proportion of cement retained in the system.

### A Cement-Retaining System

Structural modifications, such as placing venting holes in an IVA system, may be permissible if the abutment form is not substantially weakened by the modification. For example, the IVA approach is most applicable to abutments made of metal-based materials such as titanium and gold alloys. Modified zirconia or ceramic abutments, on the other hand, are more susceptible to structural failure than their metal counterparts. In such situations, a different cement-retaining system discussed in the following sections may be used to direct cement flow and retain more cement within the abutment chamber.

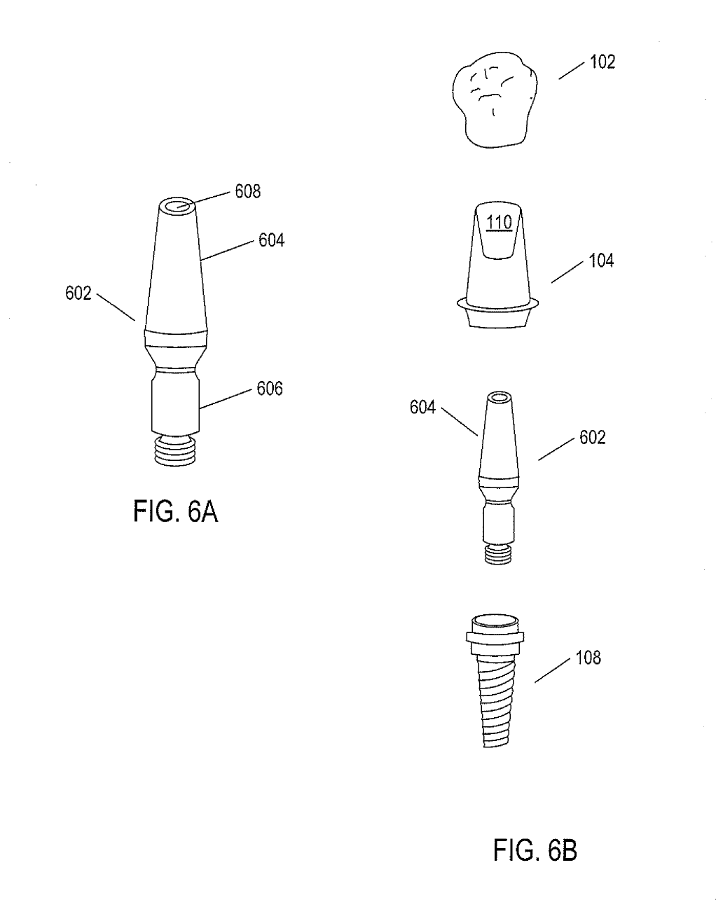

FIG. 6A shows an isometric view of a cement-retaining abutment screw. In certain implementations, the cement-retaining system may comprise an abutment screw, as shown in FIG. 1, and a longitudinal extension of the abutment screw. A cement-retaining abutment screw 602, shown in FIG. 6A, has a conical-shaped extension 604 located opposite the threaded end of the screw shaft 606. The conical extension 604 may have a screwdriver receiving socket 608 at the coronal end similar to the screwdriver receiving socket 112 in the abutment-retaining screw 106 shown in FIG. 1, which allows for engagement of a screwdriver, a torque wrench, or other suitable driving tools. The extension 604 projects into the chamber of the abutment and guides excess cement to flow into the chamber. FIG. 6B shows a dental prosthetic implant system with the cement-retaining abutment screw. In this system, the conventional abutment screw 106 shown in FIG. 1 is replaced with a cement-retaining abutment screw 602. The conical extension 604 of the screw 602 extends into the abutment chamber 110 when the abutment 104 is anchored to the implant 108 with the screw 602. The extension 604 does not change the physical nature of the abutment 104 but disperses cement to flow inside the chamber 110 during cementation of a prosthesis, which increases infill volume of cement within the chamber.

The extension 604 generally comprises an elongated body that may have various shapes, such as a cylindrical, conical, spiral, or pyramidal shape. The extension 604 may be externally threaded with thread wrapped around the conical shaft to enable engagement of suitable driving tools. The conical shape of the extension directs cement to flow around the extension and infill the cavity of the chamber. The extension can be either solid, with no internal channel, or hollow. The height of the extension is less than the vertical height of the abutment wall, with the tip of the extension not extending beyond the occlusal opening of the abutment to avoid interfere with seating of the prosthesis. In the example of FIG. 6, the extension is a continuous unit with the abutment screw.

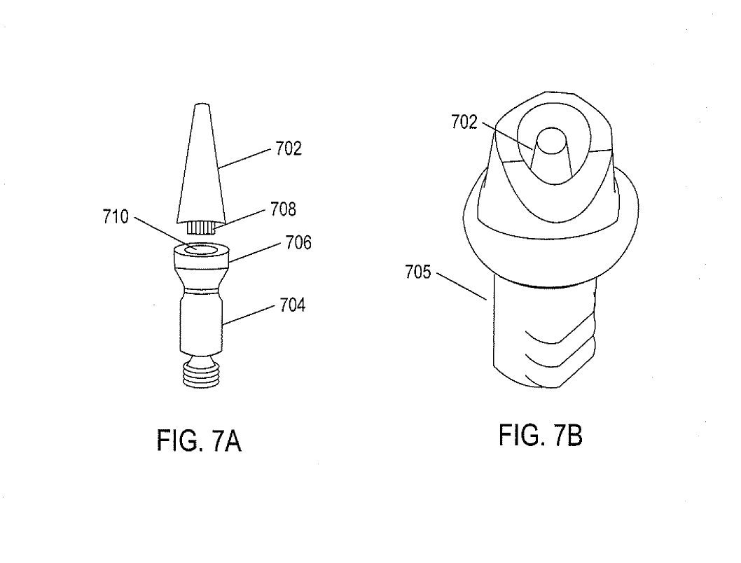

In another implementation, the extension may be fabricated as a separate unit and affixed to the head of the screw through the coronal opening of the abutment. FIG. 7A shows an example of a conical-shaped extension 702 as a separate unit from an abutment screw 704. The extension 702 includes a protrusion that extends from the base of the extension 702 for insertion into the socket 710 of screw 704. FIG. 7B shows the extension 702 seated within an abutment 705. The extension 702 is placed in the abutment chamber, and then attached to the head 706 of the abutment screw 704. Various fixation methods may be used, such as application of an adhesive to the protrusion 708 and base of the extension 702 or by friction fit of the protrusion 708 into the socket 710. The protrusion 708 may be circular, square, hexagonal shape, or any suitable shape for insertion into the socket 710. The protrusion 708 may have retention structures, such as a roughened outer surface, to improve friction fit and stability.

The extension may be made from the same material as the abutment screw, such as titanium alloy or stainless steel, or the extension may be made of polymeric materials, such as acrylic and polytetrafluoroethylene (PTFE). A common problem with implant-supported restorations is the abutment screw loosening or fracture. One of the concerns with extensions, and with cemented restorations in general, is obturation of the chamber in case the screw needs to be accessed. In order to allow easy access to the screw, the abutment extension, if fabricated as a separate unit from the screw, may be made from materials that have a lower melting point and can be easily removed. For example, the extension may be made of soluble or semi-soluble materials such as wax, sugar-based materials, silicone compounds, polyvinyl siloxane, or a rubbery substance, such as gutta-percha.

Modification of a Titanium Abutment with an Acrylic Extension

Experiments have been done to investigate the effectiveness of extensions on the retention of cement-retained restorations and cement flow. Twenty-seven identical titanium stock implant abutments from Straumann were used for the test. The abutments were attached to each implant replica with an abutment screw and torqued to 35 Ncm with a torque wrench. Copings that replicate restorations were fabricated by waxing directly to the metal abutment, as recommended by the manufacture, and were standardized by placing each abutment into a custom jig and injecting wax around it. Wax patterns were invested in a phosphate-bonded investment material, for example, Microstar® HS™ from Jensen Dental, and cast in JP-1 dental alloy from Jensen Dental to produce copings. The cast copings were examined and adjusted under an optical microscope at a magnification of 20× to assist in adaptation to their corresponding abutment. Twenty-seven copings were randomly assigned to one of the three groups: (1) closed abutment (CA); (2) open abutment (OA); and (3) insert abutment (IA). Each group had a sample of nine specimens. The CAs were closed off with composite material completely filling the abutment chamber. In the OAs, a small piece of polytetrafluoroethylene (PTFE) tape, approximately 4 mm×10 mm in dimension, was placed over the screw head to simulate the clinical practice and to prevent cement from reaching into the screwdriver engagement site. The remainder of the chamber was left unfilled. In the IAs, an extension with a conical form, for example, one shown in FIG. 7A, was fabricated from 1.2 mm diameter×5 mm long acrylic rods, then inserted into the abutment chamber and fit by friction into the screwdriver receiving socket.

Approximately 0.03 mL of cement was placed within the intaglio surface of each metal coping. The cemented coping was then seated onto an appropriate abutment, initially held with finger pressure, then placed into a spring compression device. The process was completed well within the cement's hardening time. The seated unit was loaded with 5 kg of force and allowed to set for 10 minutes. Excess cement was removed from the cemented coping-abutment system and refined using either a microscope or a chemical solvent, for example, Orange Solvent from EPR Industries.

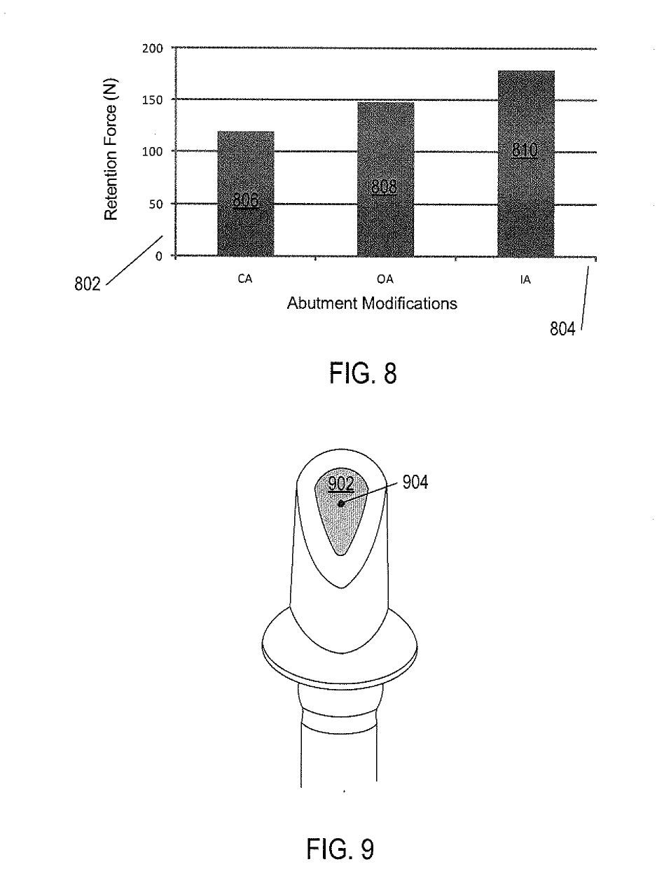

To evaluate the retention capability, the cemented copings were placed in a universal load-testing machine, for example, Model 8511 from Instron®, and subjected to a tensile failure test. A crosshead speed of 5 mm/min was used. The loads required to remove each coping from the corresponding abutment were recorded. Statistically significant differences between group means were evaluated using one-way analysis of variance (ANOVA) and Tukey honestly significant difference (HSD) test at a specified level of significance, such as α=0.05. FIG. 8 shows mean retention forces required to dislodge the cemented copings from groups of closed abutment, open abutment and insert abutment. The vertical axis 802 represents the mean retention force and the horizontal axis 804 represents the type of abutment. Vertical bars, such as vertical bar 806, represent the retention force required for each group of abutment. The mean retention force required to remove the coping from the abutment is calculated as 119.3 N for the CA group 806, 148.1 N for the OA group 808, and 179.6 for the IA group 810, with a standard deviation of 18.4 N, 16.1 N, and 31.8 N, respectively. The mean retention force required to dislodge the copings in the IA group was significantly greater than the CA and OA groups. The mean retention force value of the IA group was also comparable to the mean retention force value of the IVA group (191.5 N) determined in one of the previous experiments.

The specimens were further examined for the cement flow pattern. Removal of the copings revealed that all the abutments in the IA group were consistently filled with cement, whereas voids within the cement were observed in the OA group. FIG. 9 shows the cement flow pattern in an insert abutment. Similar to the internal-vent abutment shown in FIG. 4B, the abutment chamber 902 in the insert abutment is filled with the cement. Examination of the cement flow pattern indicated that no cement was left at the restoration-abutment margin and no air void inclusions were observed between the intaglio of the coping and the outer axial wall of the abutment. The tip 904 of the extension is still visible.

Modification of a Zirconia Abutment with a Metal Extension

Experiments were also carried out to determine how a metal extension placed within an anterior zirconia abutment affects the amount of cement retained within the restoration-abutment system and the retentive strength. In one experiment, thirty-six zirconia anterior abutments suitable for restoring maxillary incisors were fabricated from a scanned master abutment using Computer-Aided Design and Computer-Aided Manufacturing (CAD/CAM) procedure. For example, Procera® abutments manufactured by Nobel Biocare have been used for this test. The scanned master abutment was also used to fabricate thirty-six CAD/CAM zirconia restorations, with a 50 μm cement space left between the abutment and the intaglio of the restoration to accommodate the thickness of the cement film. The abutments were screw-retained to each implant analog with a torque value of 35 Nem and paired with a restoration to form an implant-restoration-abutment complex (IRAC). Thirty-six zirconia restorations were assigned to one of the three groups of abutments: (1) closed abutment (CA); (2) open abutment (OA); and (3) insert abutment (IA). Each group had a sample of twelve specimens.

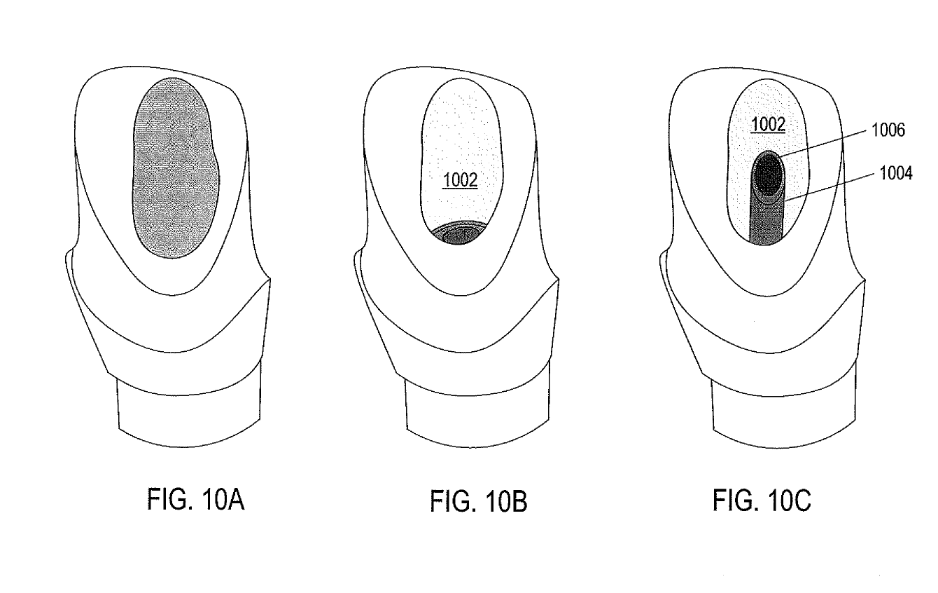

FIG. 10A shows a closed zirconia anterior abutment. The CA group served as a control. A pellet of PTFE tape, approximately 1 mm in diameter, was placed in each closed abutment to protect the screw head. The abutment chamber was then entirely filled with composite resin Herculte® XRV™ from Kerr™. FIG. 10B shows an open zirconia anterior abutment. In the OA group, the PTFE spacer was placed over the screw access, and the remainder of the abutment chamber 1002 was left open. FIG. 10C shows an insert abutment with a metal extension 1004. In the IA group, a metal extension 1004 was placed inside the chamber 1002 of the abutment. In one implementation, the metal extension was produced by cutting a metal cannula of a syringe to a length of 4 mm. Micro 20 gauge tips from Ultradent Products Inc. were used to prepare the metal extension. One end of the metal extension was pushed into the screwdriver receiving socket of the screw head and held in position by friction, and the longitudinal axis of the metal extension projected directly from the screw head toward the occlusal opening of the abutment. The extension was prepared with a bevel 1006 on the distal end, corresponding to the occlusal bevel of the abutment, and was cut not to protrude beyond the occulusal opening of the abutment to interfere with seating of the restoration. Alternatively, the metal extension and the abutment screw may be fabricated as a single unit with the screw head extending through the screw access channel to reach the occlusal opening of the abutment.

Each restoration and abutment in the three test groups were weighed and recorded before cementation. Next, Temp-Bond® NE cement from Kerr™ was selected and loaded into a 1.2 mL syringe with a fine tip (Ultradent Products) in order to reduce the possibility of air voids in the cement. Other luting cements may also be used. It is desirable that the luting cement is strong enough to retain the restorations, yet weak enough so that the restorations can be removed if required. Approximately 0.3 mL Temp-Bond® NE cement was placed into the intaglio surface of each restoration. The quantity of cement applied was greater than that the maximum volume of cement required for complete filling of the cement luting space. The cemented restorations were weighted and seated onto the corresponding abutment, initially held with finger pressure, then placed into a spring compression device. The seated unit was applied with a 50 N seating load and allowed to set on the bench for 12 minutes at a room temperature of about 25° C. The excess cement was carefully removed from the margin of each implant restoration-abutment complex (IRAC) under an optical microscope at a magnification of 20×. After being cleaned and air dried, the cemented IRAC was weighed and recorded. The assemblies were then stored in 100% humidity at 37° C. for 24 hours. To evaluate the seating discrepancy, the vertical height of the IRAC was measured using a linear transducer device capable of an accuracy of 0.5 μm, for example, Model FG2 from Keyence. The vertical heights before and after cementation ranged from −9 μm to 16 μm for thirty-four of the thirty-six specimens and showed no significant difference with a p-value larger than 0.05, confirming that the restorations have completely seated on the abutments.

One-way analysis of variance (ANOVA) was used to compare the mean weights of the abutments from the 3 groups and to determine significant differences between group means at a specified a level of significance, for example, α=0.05, and a power value of 0.80. The Tukey honestly significant difference (HSD) test was used to conduct post hoc comparisons. The mean weights of the cement retained within the IRAC were 0.0357 g for the CA group, 0.0631 g for the OA group, and 0.0581 for the IA group. Results of the one-way ANOVA indicated that the weights of cement introduced into the restoration did not show significant differences among the three groups with a P-value larger than 0.05, whereas the amount of cement retained within each IRAC system was significantly different among the three groups with a P-value smaller than 0.05. In particular, the Tukey HSD test revealed that significantly larger amount of cement was retained in both the OA group and IA group than in the CA group. No statistically significant difference was observed between the OA group and IA group. It should be noted that with the insertion in the abutment, less volume was available within the abutment chamber. The dimension of the extension was 1 mm in diameter and 4 mm in length, resulting a reduction in volume of 3.14×(0.5)²×4=3.14 mm³. While in the open abutment group the space taken up by the PTFE pellet was only 0.79 mm³, or a quarter of the extension volume.

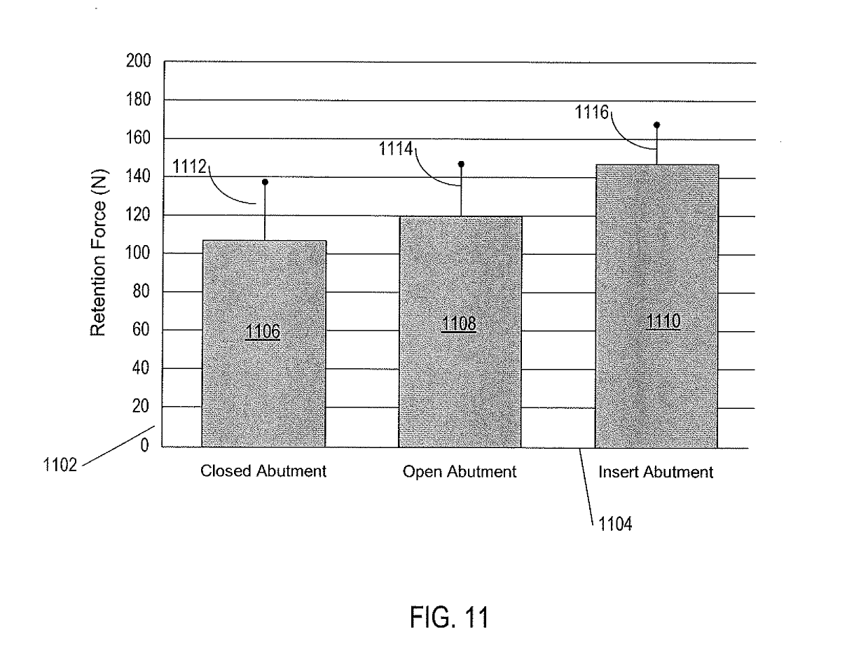

Next, the peak force required to remove the cement-retained restorations from the abutments was measured using a universal load-testing machine from Instron®. The crosshead speed was set at 5 mm/min. The tensile force required for complete separation of the restorations from the abutments was recorded. FIG. 11 shows means and standard deviations of retention force required to dislodge cemented restorations from groups of closed abutment, open abutment and insert abutment. The vertical axis 1102 represents the mean retention force and the horizontal axis 1104 represents the type of abutment. Vertical bars, such as vertical bar 1106, represent the mean retention force for each group of abutments. Vertical lines, such as vertical line 1112, represent the standard deviation for each group of abutments. The mean retention force required for dislodgement was calculated as 108.1 N for the CA group 1106, 120.7 N for the CA group 1108, and 148.3 N for the IA group 1110, with a standard derivation of 29.9 N for the CA group 1112, 27.8 N for the OA group 1114, and 21.0 N for the IA group 1116. The mean retention force required to dislodge the restorations in the IA group was significantly greater than in the CA and OA groups. Statistical analysis also confirmed that significant differences were determined between the IA group and OA group with a P-value less than 0.05, as well as between the IA group and the CA group with a P-value less than 0.01. No significant difference was determined between the OA group and CA group.

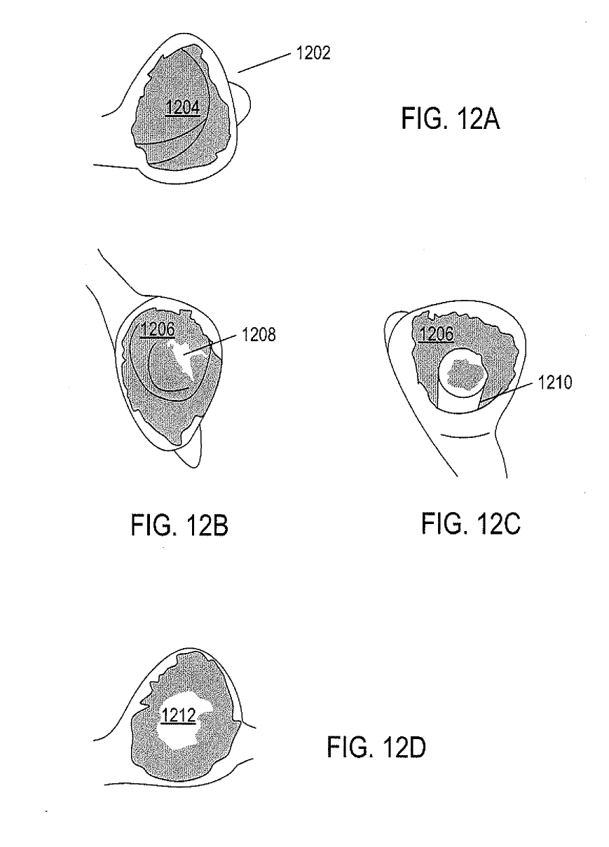

After the removal of the restorations, the specimens were further examined for the cement distribution pattern. FIG. 12A shows a cement distribution pattern for a restoration 1202 in the CA group. In all the specimens of the CA group, the intaglio surface of the restoration was covered with cement, while there was no cement left on the abutment surface. FIG. 12B shows a cement distribution pattern for a first restoration in the OA group. For the OA group, in eight out of the twelve specimens, the fitting surface of the restoration was covered with cement 1206 but with a block of cement-free zone 1208 on the intaglio of the restoration. FIG. 12C shows a cement distribution pattern for a second restoration in the OA group. In this case, complete removal of the cement as well as the PTFE spacer 1210 was observed. In both cases, the abutment chamber was partially filled with cement 1206. For the IA group, similar to the IA described previously in FIG. 9, the abutment chamber of all the specimens in IA group was filled with cement, and neither air bubbles nor void space were observed in the cement. FIG. 12D shows a cement distribution pattern for a restoration in the IA group. For all the restorations removed from the abutments, a larger cement-free zone 1212 was observed on the intaglio surface of the restoration, with a block of cement always left in the screw access channel, indicating more cement was retained within the access channel. The cement-free zone corresponded to the screw access channel of the abutment. The different failure modes indicate again that with increase in amount of cement retained in the abutment, there is a resultant increase in retention. A more dispersed fill of the abutment chamber may provide a more uniform structural reinforcement, leading to high retention strength. The increased retention force may also be partially due to an additional force needed to cause a partial fracture within cement at the abutment-restoration interface.

Although the present disclosure has been described in terms of particular implementations, it is not intended that the disclosure be limited to these implementations. Modifications will be apparent to those skilled in the art. For example, as disclosed above, various abutment configurations, including shape and design of abutments, wall height, platform size, surface roughness, and other modifications, various screw access channel filling methods, types of luting cement, or other set of properties can be changed to produce a variety of different systems to be used in various implant-supported abutments. The precise configuration and dimension of the cement-retaining system may also vary depending upon the configuration and dimension of the abutment or other dental components. The cement-retaining systems disclosed in the current document can be used with abutments and other dental components made from various materials, including metal alloys and ceramic materials.

The foregoing description, for purposes of explanation, used specific nomenclature to provide a thorough understanding of the invention. However, it will be apparent to one skilled in the art that the specific details are not required in order to practice the invention. The foregoing descriptions of specific implementations of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various implementations with various modifications as are suited to the particular use contemplated. It is intended that the scope of the invention be defined by the following claims and their equivalents.

1. A cement-retaining abutment screw comprising:
a shaft having a head and a threaded end, the threaded end having external threading that is adapted to engage with a threaded socket in a dental implant; and
an extension, at the head of the shaft, which channels excess cement into an abutment chamber.

2. The cement-retaining abutment screw of claim 1, wherein the extension is separate from the shaft.

3. The cement-retaining abutment screw of claim 2, wherein the extension further comprises a protrusion that extends from a base of the extension, the protrusion to be inserted into a socket located in the head of the shaft.

4. The cement-retaining abutment screw of claim 2, wherein the extension is formed from one of a soluble material and a semi-soluble material.

5. The cement-retaining abutment screw of claim 1, wherein the extension is a continuous unit with the shaft.

6. The cement-retaining abutment screw of claim 5, wherein the extension further comprises a coronal end configured to engage a screw driving device.

7. The cement-retaining abutment screw of claim 1, wherein the extension has one of the shapes selected from among:
cone;
spiral;
cylinder; and
pyramid.

8. The cement-retaining abutment screw of claim 1, wherein the extension is formed from one or more of the materials selected from among:
titanium;
stainless steel;
sugar;
wax;
silicone;
polyvinyl siloxane; and
gutta-percha.

9. A system comprising:
a dental implant with an internally threaded socket and an externally threaded body to be anchored in a jawbone;
an abutment having a chamber and a coronal opening, the abutment to be placed on the implant;
a cement-retaining abutment screw to secure the abutment to the implement, the screw comprising:
a shaft having a head and a threaded end, the threaded end to engage the threaded socket in the dental implant, and
an extension at the head of the shaft; and
a dental restoration with an intaglio surface configured to receive the abutment, such that when cement is placed on the intaglio surface, the extension channels excess cement into the chamber.

10. The system of claim 9, wherein the extension is separate from the shaft.

11. The system of claim 10, wherein the extension further comprises a protrusion that extends from a base of the extension, the protrusion to be inserted into a socket located in the head of the shaft.

12. The system of claim 10, wherein the extension is formed from one of a soluble material and a semi-soluble material.

13. The system of claim 9, wherein the extension is a continuous unit with the shaft.

14. The system of claim 13, wherein the extension further comprises a coronal end configured to engage a screw driving device.

15. The system of claim 9, wherein the extension has one of the shapes selected from among:
cone;
spiral;
cylinder; and
pyramid.

16. The system of claim 9, wherein the extension is formed from one or more of the materials selected from among:
titanium;
stainless steel;
sugar;
wax;
silicone;
polyvinyl siloxane; and
gutta-percha.

17. A method for attaching a restoration to a dental implant, the method comprising:
inserting a dental implant into a jawbone, the dental implant with an internally threaded socket and an externally threaded body;
placing an abutment on the implant, the abutment having a chamber and a coronal opening;
inserting a cement-retaining abutment screw into the internally threaded socket through the coronal opening of the abutment, the screw comprising:
a shaft having a head and a threaded section, the threaded section having external threading that is adapted to engage with the threaded socket in the dental implant, and
an extension at the head of the shaft, the extension protruding into the chamber;
applying cement to an intaglio surface of a dental restoration, the intaglio surface configured to receive the abutment; and
pressing the dental restoration onto the abutment, the extension to channel excess cement into the chamber.

18. The method of claim 17, wherein the extension is separate from the shaft.

19. The method of claim 18, wherein the extension further comprises a protrusion that extends from a base of the extension, the protrusion to be inserted into a socket located in the head of the shaft.

20. The method of claim 18, wherein the extension is formed from one of a soluble material and a semi-soluble material.

21. The method of claim 17, wherein the extension is a continuous unit with the shaft.

22. The method of claim 21, wherein the extension further comprises a coronal end configured to engage a screw driving device.

23. The method of claim 17, wherein the extension has one of the shapes selected from among:
cone;
spiral;
cylinder; and
pyramid.

24. The method of claim 17, wherein the extension is formed from one or more of the materials selected from among:
titanium;
stainless steel;
sugar;
wax;
silicone;
polyvinyl siloxane; and
gutta-percha.
